(19) United States
(12) Patent Application Publication
(10) Pub. No.: US 2005/0017182 A1
(43) Pub. Date: Jan. 27, 2005

(54) Registered collimator device for nuclear imaging camera and method of forming the same

(75) Inventors: Jinhun Joung, Algunquin, IL (US); Samir Chowdhury, Chicago, IL (US)

Correspondence Address: Elsa Keller;Siemens Corporation, Intellectual Property Department, 170 Wood Avenue South, Iselin, NJ, 08830, US

(73) Assignee: Siemens Medical Solutions USA, Inc.

(21) Appl. No.: 10/627,844

(22) Filed: Jul. 25, 2003

(51) Int. Cl. G01T 1/20

(52) U.S. Cl. 250/363.1; 250/367; 250/505.1

(57) ABSTRACT

A collimator device for a nuclear imaging camera has a grid of collimation square holes formed by a plurality of elongated, metal sheets arranged in a grid pattern, and pixellated scintillators individually located in each of the collimation square holes. Each of the metal sheets has evenly spaced slots into which other sheets are inserted. At least a portion of the surfaces of the sheets forming the grid of the collimation square holes is coated with an optically reflecting material coating.

### BACKGROUND OF THE INVENTION

1. Field of the Invention

The present invention generally relates to nuclear medicine, and systems for obtaining nuclear medicine images of a patient's body organs of interest. In particular, the present invention relates to a novel registered collimator device for a nuclear imaging camera and a method of forming the same.

2. Description of the Background Art

Nuclear medicine is a unique medical specialty wherein radiation is used to acquire images that show the function and anatomy of organs, bones or tissues of the body. Radiopharmaceuticals are introduced into the body, either by injection or ingestion, and are attracted to specific organs, bones or tissues of interest. Such radiopharmaceuticals produce gamma photon emissions that emanate from the body. One or more detectors are used to detect the emitted gamma photons, and the information collected from the detector(s) is processed to calculate the position of origin of the emitted photon from the source (i.e., the body organ or tissue under study). The accumulation of a large number of emitted gamma positions allows an image of the organ or tissue under study to be displayed.

Two basic types of imaging techniques are PET or coincidence imaging, and single photon imaging, also known as planar or SPECT imaging. PET imaging is fundamentally different from single photon imaging. In PET, events are detected from the decay or annihilation of a positron. When a positron is annihilated within a subject, two 511 KeV gamma rays are simultaneously produced which travel in approximately opposite (i.e., 180°) directions. Two scintillation detectors are positioned on opposite sides of the patient such that each detector will produce an electrical pulse in response to the interaction of the respective gamma rays with a scintillation crystal. In order to distinguish the detected positron annihilation events from background radiation or random events, the events must be coincident (i.e., both occur within a narrow time window) in each detector in order to be counted as “true” events. When a true event is detected, the line connecting the positions of the two points of detection is assumed to pass through the point of annihilation of the positron within the subject being imaged.

By contrast, single photon imaging, either planar or SPECT, relies on the use of a collimator (e.g., a pattern of holes through gamma ray absorbing material, usually lead or tungsten) placed in front of a scintillation crystal or solid state detector, to allow only gamma rays aligned with the holes of the collimator to pass through to the detector, thus inferring the line on which the gamma emission is assumed to have occurred. Both PET and single photon imaging techniques require gamma ray detectors that calculate and store both the position of the detected gamma ray and its energy.

The advantages offered by these systems include the availability of arrays of small detector units of any size and shape, the efficiency of the scintillation light collection, and the location of the detector placed relative to an object. However, detection sensitivity and spatial resolution can be improved.

The classic tradeoff between collimator spatial resolution and sensitivity is an important consideration in the design of a collimator. Traditional scintillation cameras use hexagonal hole collimators. Hexagonal hole collimators are more readily available and have a more symmetric septa penetration pattern compared to that of square holes. Thus, they are quite suitable for the conventional scintillation systems in which a relatively large, single slab of continuous Nal(Tl) crystal is employed.

Often times, a conventional hexagonal collimator is not an optimum collimation device for a discrete/pixellated scintillator system due to the geometric mismatch in terms of hole size and shape between conventional hexagonal collimator holes and square detector pixels. Accordingly, registered collimators consisting of square holes, precisely registered 1-to-1 to square pixellated scintillators, provide a superior system point spread response with minimal dependence on source position by eliminating alignment problems caused by geometric mismatch of collimator holes to pixellated crystals.

However, the registered collimators consisting of square holes create other problems. Machining and drilling of the registered square holes from a block of lead or tungsten can be labor intensive, wasteful (e.g., materials), and expensive. It is also difficult to machine thin septa and maintain uniform thickness. In most cases, the required septa thickness is on the order of several hundreds of micrometers and the non-uniform septa thickness is likely to generate an asymmetric system point spread response. Moreover, precise alignment between collimator holes and individual pixellated crystals are problematic.

Further, optical isolation of individual crystals is required to maximize light output and event position estimation. This is accomplished by wrapping or painting reflective material, such as Teflon film (TiO₂) or MgO powder. Event misposition caused by intercrystal scatter increases as the length of the scintillator increases or the energy of imaging isotopes gets higher.

U.S. patent application Publication No. 2002/0175289 A1 (Soluri et al.) entitled [symbol] High Spatial Resolution Scintigraphic Device Having Collimator with Integrated Crystals [symbol] discloses a collimator with integrated crystals to address alignment problems. However, the prior art does not address issues regarding collimator fabrication difficulties and/or reflective treatment.

Accordingly, there remains a need for a system and methodology for overcoming the shortcomings of the prior art, such as a novel registered collimator device for a nuclear imaging camera and a method of forming the same.

### SUMMARY OF THE INVENTION

The present invention is provided to solve the above-mentioned problems. According to an aspect of the present invention, there is provided a collimator device for a nuclear imaging camera comprising a grid of collimation square holes formed by a plurality of elongated, metal sheets arranged in a grid pattern, and pixellated scintillators individually located in each of the collimation square holes. Each of the metal sheets has evenly spaced slots into which other sheets are inserted. At least a portion of the surfaces of the sheets forming the grid of the collimation square holes is coated with an optically reflecting material coating.

According to another aspect of the present invention, there is provided a scintigraphic device comprising a collimator device, and a detector coupled to pixellated scintillators and operable to detect radiation emanating from an object and interacting with the scintillators after passing through the collimator device. The collimator device includes a grid of collimation square holes formed by a plurality of sheets arranged in a grid pattern, and pixellated scintillators individually located in each of the collimation square holes. Each is of the sheets have evenly spaced slots into which other sheets are inserted. At least a portion of the surfaces of the sheets forming the grid of the collimation square holes is coated with an optically reflecting material.

According to yet another aspect of the present invention, there is provided a method of forming a collimator device comprising forming a plurality of evenly spaced slots across a longitudinal direction of a plurality of sheets, arranging the plurality of sheets in a grid pattern by inserting a sheet into each of the slots and thereby forming a grid of collimation square holes, and inserting pixellated scintillators into each of the collimation square holes. At least a portion of the surfaces of the sheets forming the grid of the collimation square holes is coated with an optically reflecting material.

According to yet another aspect of the present invention, there is provided a building block for forming a collimation device of a nuclear medical imaging camera, comprising an elongated sheet of metallic material having a thickness suitable for functioning as septa of the collimation device, and having a plurality of evenly spaced slots into which other elongated sheets are inserted in order to form a grid pattern of collimation holes into which pixellated scintillators are placed.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1A schematically shows a collimator device according to an exemplary embodiment of the present invention;

FIG. 1B is a front elevation view of a metal sheet used to form collimation square holes of the collimator device according to an exemplary embodiment of the present invention; and

FIG. 2 is a flow chart of the method of forming a collimator device according to an exemplary embodiment of the present invention.

### DETAILED DESCRIPTION OF THE PREFERRED EMBODIMENTS

In the following detailed description of the preferred embodiment, reference is made to the accompanying drawings which form a part hereof and in which is shown by way of illustrating a specific embodiment in which the invention may be practiced. This embodiment is described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

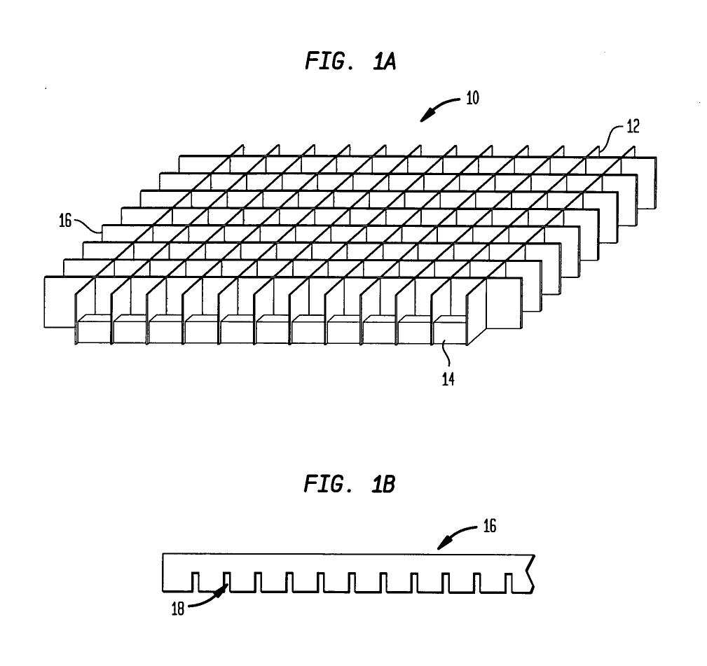

FIG. 1A schematically shows a collimator device according to an exemplary embodiment of the present invention. Referring to FIG. 1A, according to one preferred embodiment of the invention, a collimator device 10 for a nuclear imaging camera comprises a grid of collimation square holes 12 and pixellated scintillators 14 inserted into each of the holes 12.

As best seen in FIG. 1B, an elongated metal sheet 16 has evenly spaced slots 18 into which other sheets 16 are inserted. The metal sheet 16 is formed of a material having a high density, such as tungsten, lead, gold, palladium, tantalum, etc.

The surfaces of the metal sheet 16 are coated with an optically reflecting material, such as TiO₂ and MgO. The entire surface or a portion of the surface may be coated with the reflecting material. It will be appreciated by those skilled in the art that the metal sheets can be coated with the reflecting material prior to forming the evenly spaced slots, after the slots are formed, or after the sheets are arranged in the grid pattern. The reflecting material provides optical isolation between the pixellated scintillators 14, and thereby maximizes the useful output intensity of each scintillator crystal. Further, the reflecting material eliminates the need of reflective wrapping of individual pixellated scintillators 14.

The grid of collimation square holes 12 is formed by arranging a plurality of the metal sheets 16 in a grid pattern as shown in FIG. 1A. The metal sheets 16 are inserted perpendicular to each other thereby forming the grid of collimation square holes 12. The grid acts as a collimator, and as a housing for the pixellated scintillators 14. Each collimation square hole 12 has opposing lateral surface faces. In the exemplary embodiment, the size of collimation square holes 12 should be the same size as the cross section of a given pixellated scintillation crystal, typically about 1˜5 mm². If septal penetration is to be less than 5 percent and the size of the square hole is 0.25 cm and 2.5 cm long, the collimation square holes 12 are separated by septa of minimum thickness, approximately 0.030 cm and 0.020 cm at 150 keV using materials with lead and tungsten, respectively. It will be appreciated by those skilled in the art that the length, septa thickness, and dimension of the square holes are subject to change based on the sensitivity and spatial resolution trade off, and the cross section and length of the pixellated scintillators 14 as determined by particular imaging applications for the device.

The pixellated scintillators 14 are individually inserted and located in each of the collimation square holes 12 of the grid (i.e., optically isolated). The pixellated scintillators 14 are scintillation crystals, and the cross section of scintillation crystal determines intrinsic spatial resolution of the system. For instance, the typical intrinsic spatial resolution for gamma cameras in nuclear medicine is about 4˜5 mm in FWHM and some high resolution systems have 1˜2 mm FWHM intrinsic spatial resolution. Each pixellated scintillator 14 has opposing lateral surface faces, an output face and a base face. The pixellated scintillators 14 have a square-shaped configuration that is the same as the shape of the collimation square holes 12. Thus, a geometric alignment is achieved to guide photons into specific areas of the individual elements of the collimator device 10. The pixellated scintillators 14 convert gamma radiation from a patient's body organs of interest into light radiation.

A detector (not shown) can be coupled to the pixellated scintillators 14 of the collimator device 10 for detecting light radiation emanating from the scintillator.

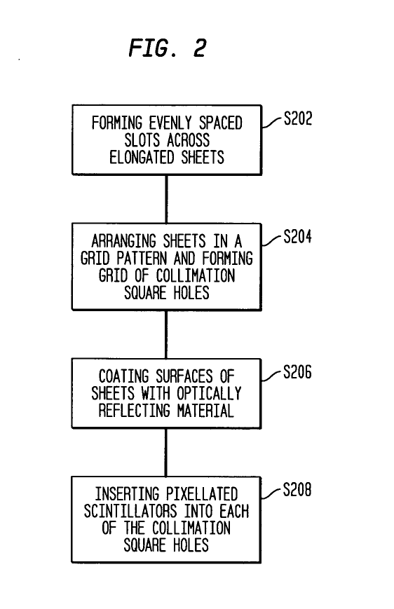

The present invention provides a novel fabrication method for a registered collimator for a nuclear imaging camera. Referring to FIG. 2, evenly spaced slots are formed in a longitudinal direction across the length of each of a plurality of elongated sheets in step S202. The surfaces of the sheets forming the collimation square holes are coated with an optically reflecting material in step S204. The plurality of elongated sheets are arranged in a grid pattern by inserting a sheet into each of the slots (step S206), such that a perpendicular grid pattern of collimation square holes is formed. Pixellated scintillators are individually inserted into each of the collimation square holes of the grid in step S208. According to the above method, extremely thin septa can be used if required.

The advantages pertain to the fabrication of the collimator device. Using metal sheets to form a grid of collimation square holes prevents the need for machining and drilling holes in a block of metal. The present invention provides metal sheets that can be inserted perpendicular to other sheets to form the grid, thereby reducing the costs of material and labor.

Another advantageous application of the invention relates to the alignment of the pixellated scintillators and collimation square holes. Both the pixellated scintillators and collimation square holes have the same geometric configuration. Accordingly, the collimator spatial resolution and sensitivity do not have to be compromised.

In addition, intercrystal scatter is eliminated since the surfaces of the metal sheets are coated with a reflecting material that maximizes the usable light intensity of pixellated scintillator events.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

While exemplary embodiments of the present invention have been described above, it should be understood that they have been presented by way of example only, and not limitation. Thus, the breadth and scope of the present invention should not be limited by the above-described exemplary embodiment.

Obviously, numerous modifications and variations of the present invention are possible in light of the above teachings. It is therefore to be understood that the invention may be practiced otherwise than as specifically described herein.

1. A collimator device for a nuclear imaging camera, comprising:
a grid of collimation square holes formed by a plurality of sheets arranged in a grid pattern, each of said sheets having evenly spaced slots into which other sheets are inserted;
optically reflecting material coating at least a portion of the surfaces of said sheets forming said grid of said collimation square holes; and
pixellated scintillators individually located in each of said collimation square holes.

2. The device of claim 1, wherein said optically reflecting material maximizes light intensity of pixellated scintillators events.

3. The device of claim 1, wherein said pixellated scintillators are scintillation crystals.

4. The device of claim 1, wherein said pixellated scintillators have a square-shaped configuration.

5. The device of claim 1, wherein said plurality of sheets are formed of a material having a high density.

6. The device of claim 5, wherein the high density material is tungsten.

7. The device of claim 5, wherein the high density material is lead.

8. The device of claim 1, wherein the reflecting material is TiO₂.

9. The device of claim 1, wherein the reflecting material is MgO.

10. A scintigraphic device, comprising:
a collimator device including
a grid of collimation square holes formed by a plurality of sheets arranged in a grid pattern, each of said sheets having evenly spaced slots into which other sheets are inserted;
optically reflecting material coating at least a portion of the surfaces of said sheets forming said grid of said collimation square holes; and
pixellated scintillators individually located in each of said collimation square holes; and
a detector coupled to said pixellated scintillators and operable to detect radiation emanating from an object and interacting with said scintillators after passing through said collimator device.

11. The device of claim 10, wherein said optically reflecting material maximizes light intensity of pixellated scintillators events.

12. The device of claim 10, wherein said pixellated scintillators are scintillation crystals.

13. The device of claim 10, wherein said pixellated scintillators have a square-shaped configuration.

14. The device of claim 10, wherein said plurality of sheets are formed of a material having a high density.

15. The device of claim 14, wherein the high density material is tungsten.

16. The device of claim 14, wherein the high density material is lead.

17. The device of claim 10, wherein the reflecting material is TiO₂.

18. The device of claim 10, wherein the reflecting material is MgO.

19. A method of forming a collimator device, comprising:
forming a plurality of evenly spaced slots across a longitudinal direction of a plurality of sheets;
arranging said plurality of sheets in a grid pattern by inserting a sheet into each of said slots and thereby forming a grid of collimation square holes;
coating at least a portion of the surfaces of said sheets forming said grid of said collimation square holes with an optically reflecting material; and
inserting pixellated scintillators into each of said collimation square holes.

20. The method of claim 19, wherein said optically reflecting material maximizes light intensity of pixellated scintillators events.

21. The method of claim 19, wherein said pixellated scintillators are scintillation crystals.

22. The method of claim 19, wherein said pixellated scintillators have a square-shaped configuration.

23. The method of claim 19, wherein said plurality of sheets are formed of a material having a high density.

24. The method of claim 23, wherein the high density material is tungsten.

25. The method of claim 23, wherein the high density material is lead.

26. The method of claim 19, wherein the reflecting material is TiO₂.

27. The method of claim 19, wherein the reflecting material is MgO.

28. A building block for forming a collimator device of a nuclear medical imaging camera, comprising an elongated sheet of metallic material having a thickness suitable for functioning as septa of said collimation device, and having a plurality of evenly spaced slots into which other elongated sheets are inserted in order to form a grid pattern of collimation holes into which pixellated scintillators are placed.
